(19) United States
(12) Patent Application Publication
(10) Pub. No.: US 2008/0048961 A1
(43) Pub. Date: Feb. 28, 2008

(54) Method for improving image quality differences on an LCD due to different viewing modules

(76) Inventors: Tai-Hsin Liu, Taipei City (TW); Pao-Ming Shih, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/508,876

(22) Filed: Aug. 24, 2006

(51) Int. Cl. G09G 3/36

(52) U.S. Cl. 345/88

(57) ABSTRACT

A method for improving image quality differences on an LCD due to different viewing modules, includes: transforming an image data from a spatial domain with the luminance signal and the chrominance signal to a spatial domain with three color signals; adjusting the LCD's luminance, color and contrast parameters according to luminance, color and contrast displays to all the image data that the luminance, color and contrast displays need; transforrming the image data from the spatial domain with three color signals to the spatial domain with the luminance signal and the chrominance signal; and displaying the image data on the adjusted LCD and in playback module.

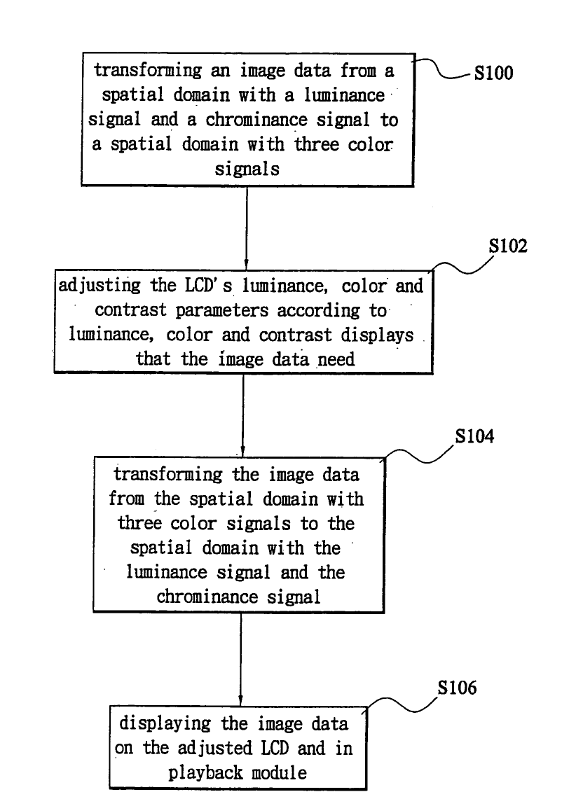

### BACKGROUND OF THE INVENTION

1. Field of The Invention

The present invention relates to a method for improving image quality differences on an LCD due to different viewing modules, and particularly relates to a method for improving image quality differences on an LCD due to two different viewing modules between a live viewing module and a playback module.

2. Description of the Related Art

There are many methods for people to commemorate an occasion. One common way is by taking pictures, because any occasion such as travel, a celebration, an event or any good time that deserves to be commemorated can be recorded via a camera. Moreover, it is convenient for users to transmit image data from the camera to an electronic device such as a computer for modifying the image data. In addition, the price of a camera has become increasingly cheaper, so the number of people using digital cameras increases day by day.

However, when a digital camera is in a live viewing module, images will produce serious dark angle problems on an LCD of the camera due to the shading of the lens. In order to solve the problem, a preview gamma set is used to decrease the dark angle problems of the prior art. However, when a user takes a picture, a capture gamma is usually used in the playback module of the LCD. Hence, two different sets of gamma are used in the LCD at the same time, so that the image's brightness and color in the live viewing module are different from that of the image in the playback module.

### SUMMARY OF THE INVENTION

The present invention provides a method for improving image quality differences on an LCD due to different viewing modules. The image quality differences occurring on the LCD due to a difference between a preview gamma and a capture gamma are improved via a transformation method between the YUV domain and the RGB domain and a modification method in the RGB domain. Hence, the serious dark angle problems on the LCD of a camera due to the shading of the lens can be solved, and the image's brightness and color in the live viewing module are similar to that of the image in the playback module.

One aspect of the present invention is a method for improving image quality differences on an LCD due to different viewing modules, comprising: transforming an image data from a spatial domain with the luminance signal and the chrominance signal to a spatial domain with three color signals; adjusting the LCD's luminance, color and contrast parameters according to all the image data that the luminance, color and contrast displays need; transforming the image data from the spatial domain with three color signals to the spatial domain with the luminance signal and the chrominance signal; and displaying the image data on the adjusted LCD and in playback module.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

The Figure is a flow chart of a method for improving image quality differences on an LCD due to different viewing modules of the present invention.

### DETAILED DESCRIPTION OF PREFERRED BEST MOLDS

Referring to the Figure, the present invention provides a method for improving image quality differences on an LCD due to different viewing modules. In addition, the LCD is a kind of LCD in which the luminance, color and contrast are unable to be adjusted.

The method comprises: firstly, transforming an image data from a spatial domain with a luminance signal and a chrominance signal to a spatial domain with three color signals (S100). In addition, the image is stored in a memory of the LCD, and the spatial domain with the luminance signal and the chrominance signal can be a YUV domain that is called a YC_{b}Cᵣ domain. The spatial domain with three color signals can be a RGB domain. The color spatial transforming formula for transforming the YC_{b}Cᵣ domain to the RGB domain is as follows:

R=1.164(Y)+1.596(C_{b}−128)

G=1.164(Y)−0.813(Cᵣ−128)−0.392(C_{b}−128)

B=1.164(Y)+2.017(C_{b}−128).

Moreover, the method further comprises: adjusting the LCD's luminance, color and contrast parameters according to luminance, color and contrast displays that the image data need (S102). In addition, the luminance parameter is a green gain (G gain) of a digital gain, the color parameter is a red gain (R gain) and a blue gain (B gain) of a digital gain, and the contrast parameter is a gamma curve.

Furthermore, the method further comprises: transforming the image data from the spatial domain with three color signals to the spatial domain with the luminance signal and the chrominance signal (S104); and then displaying the image data on the adjusted LCD and in playback module (S106). In addition, in the step of S104, if the image data is transformed from the RGB domain to the YC_{b}Cᵣ domain, the color spatial transforming formula is as follows:

Y=0.257R+0.504G+0.098B

C_{b}=−0.148R−0.291G+0.439B

Cᵣ=0.439R−0.368G−0.071B.

In conclusion, the image's spatial domain is a YUV domain (or a YC_{b}Cᵣ domain) in playback module. Hence, if a user wants to modify the image's color appearance, the image's spatial domain needs to be transformed from the YUV domain to the RGB domain. Moreover, a digital gain (R gain, G gain and B gain) or a gamma curve (or a gamma table) needs to be adjusted according to a color appearance as desired by a user. Finally, the image is transformed from the RGB domain to the YUV domain via DSP (Digital Signal Process). Hence, the image's brightness and color in the live viewing module are similar to that of the image in the playback module.

Furthermore, the image quality differences on the LCD due to the difference between the preview gamma and the capture gamma are improved via the transformation method between the YUV domain and the RGB domain and the modification method in the RGB domain. Hence, the serious dark angle problems on the LCD of a camera due to the shading of the lens are solved. The image's brightness and color in the live viewing module are similar to that of the image in the playback module.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for improving image quality differences on an LCD due to different viewing modules, comprising:
transforming an image data from a spatial domain with a luminance signal and a chrominance signal to a spatial domain with three color signals;
adjusting the LCD's luminance, color and contrast parameters according to luminance, color and contrast displays that the image data need;
transforming the image data from the spatial domain with three color signals to the spatial domain with the luminance signal and the chrominance signal; and
displaying the image data on the adjusted LCD and in playback module.

2. The method as claimed in claim 1, wherein the LCD is a kind of LCD in which the luminance, color and contrast are unable to be adjusted.

3. The method as claimed in claim 1, wherein the spatial domain with the luminance signal and the chrominance signal is a YUV domain.

4. The method as claimed in claim 1, wherein the spatial domain with three color signals is a RGB domain.

5. The method as claimed in claim 1, wherein the luminance parameter is a green gain (G gain) of a digital gain.

6. The method as claimed in claim 1, wherein the color parameter is a red gain (R gain) and a blue gain (B gain) of a digital gain.

7. The method as claimed in claim 1, wherein the contrast parameter is a gamma curve.
